(19) United States
(12) Patent Application Publication
(10) Pub. No.: US 2026/0368840 A1
(43) Pub. Date: Nov. 19, 2026

(54) VEHICLE ALLOCATION MANAGEMENT DEVICE AND VEHICLE ALLOCATION MANAGEMENT METHOD

(71) Applicant: NISSAN MOTOR CO., LTD., Kanagawa (JP)

(72) Inventors: Ayaka Watanuki, Kanagawa (JP); Shigeki Sato, Kanagawa (JP); Tomoki Hirabayashi, Kanagawa (JP)

(73) Assignee: Nissan Motor Co., Ltd., Kanagawa (JP)

(21) Appl. No.: 19/142,726

(22) PCT Filed: Dec. 27, 2022
(86) PCT No.: PCT/JP2022/048337

§ 371 Date: Jun. 24, 2025

(51) Int. Cl. G06Q 50/40; G06Q 10/0631

(52) U.S. Cl. CPC G06Q 50/40; G06Q 10/06315

(57) ABSTRACT

A vehicle allocation management device for managing allocation of a vehicle in response to a vehicle allocation request includes a vehicle allocation request acquisition unit configured to acquire a vehicle allocation request in which at least a desired pick-up point is indicated; a vehicle information database configured to store vehicle information including information about vehicle performance and associated with each of a plurality of vehicles; a vehicle allocation plan generation unit configured to generate a vehicle allocation plan including at least an operation route with respect to each of two or more candidate vehicles being extracted from the plurality of vehicles based on the acquired vehicle allocation request, and to confirm the vehicle allocation plan of the specific vehicle selected from the generated vehicle allocation plans; and a vehicle allocation instruction unit configured to transmit the confirmed vehicle allocation plan to the specific vehicle. The vehicle allocation plan generation unit includes: a route characteristic determination unit configured to determine route characteristics with respect to the operation route; a vehicle performance identification unit configured to identify vehicle performance of the candidate vehicle, based on the vehicle information stored in the vehicle information database; and a vehicle selection unit configured to select the specific vehicle having the vehicle performance matching the determined route characteristics.

### TECHNICAL FIELD

The present invention relates to a vehicle allocation management technology, and in particular, relates to a vehicle allocation management device and a vehicle allocation management method that manage allocation of a vehicle based on an on-demand system.

### BACKGROUND ART

A mobility service is a service that smoothly provides movement of a user or transportation of a package by use of a vehicle. A car-sharing service that enables shared use by a plurality of users of an idle vehicle parked in a nearby parking lot on a predetermined usage time basis and a ride-sharing service such as so-called ride-sharing by a plurality of passengers are examples of the mobility service. In the mobility service, in order to, while increasing a utilization rate of a vehicle, improve convenience of a user (passenger), an efficient arrangement plan of vehicles is required to be made.

For example, Patent Document 1 described below discloses a vehicle allocation service system that allocates a vehicle matching condition information (urinary conditions, types of various diseases, conditions of an injury, a degree of priority, and the like) of a user.

### CITATION LIST

### Patent Literature

Patent Document 1: JP 2020-119038 A

### SUMMARY OF INVENTION

### Technical Problem

In the mobility service, a vehicle allocated according to a vehicle allocation request from a user travels along an operation route from a pick-up point to a drop-off point that the user desires. In such an operation route, various characteristics (route characteristics) due to road circumstances, traffic circumstances, and the like exist, and a vehicle that does not match such route characteristics exists depending on characteristics (performance) of the vehicle. Since in the technology disclosed in PTL 1 described above, no vehicle performance matching route characteristics is taken into consideration at the time of allocation of a vehicle, there has been a risk that a vehicle that is not sufficiently suitable for travel to a destination is allocated. In particular, in a case of an autonomous driving vehicle capable of autonomously traveling, there is a problem in that unless vehicle performance is sufficiently taken into consideration according to route characteristics, a vehicle cannot be appropriately operated to a destination. For example, in a case of an operation route including route characteristics such as a heavy human traffic, allocation of a vehicle sufficiently provided with a function to cope with an obstacle around the vehicle (such as a detection function, a recognition function, and a mobility function) is desirable.

Accordingly, an object of the present invention is to provide a vehicle allocation management device and a vehicle allocation management method that are capable of improving a level of service (LoS) by enabling a vehicle having vehicle performance matching travel route characteristics to be appropriately allocated for a vehicle allocation request from a user.

### Solution to Problem

To solve the problems described above, the present invention is configured to include the matters used to specify the invention and technical features described below.

The present invention according to one aspect is a vehicle allocation management device configured to manage allocation of a vehicle in response to a vehicle allocation request. The vehicle allocation management device comprises: a vehicle allocation request acquisition unit configured to acquire a vehicle allocation request in which at least a desired pick-up point is indicated; a vehicle information database configured to store vehicle information including information about vehicle performance, the vehicle information being associated with each of a plurality of vehicles; a vehicle allocation plan generation unit configured to generate a vehicle allocation plan including at least an operation route with respect to each of two or more candidate vehicles extracted from the plurality of vehicles based on the acquired vehicle allocation request, and confirm the vehicle allocation plan of a specific vehicle selected from the generated vehicle allocation plans; and a vehicle allocation instruction unit configured to transmit the confirmed vehicle allocation plan to the specific vehicle. The vehicle allocation plan generation unit includes: a route characteristic determination unit configured to determine route characteristics with respect to the operation route; a vehicle performance identification unit configured to identify vehicle performance of the candidate vehicle based on the vehicle information stored in the vehicle information database; and a vehicle selection unit configured to select the specific vehicle having the vehicle performance matching the determined route characteristics.

Further, the present invention according to another aspect is a vehicle allocation management method performed by a vehicle allocation management device configured to manage allocation of a vehicle in response to a vehicle allocation request. The method includes: storing vehicle information including information about vehicle performance and associated with each of a plurality of vehicles, in a vehicle information database; acquiring a vehicle allocation request in which at least a desired pick-up point is indicated from a terminal device of a user; generating a vehicle allocation plan including at least an operation route with respect to each of two or more candidate vehicles extracted from the plurality of vehicles based on the acquired vehicle allocation request; confirming the vehicle allocation plan of a specific vehicle selected from the generated vehicle allocation plans; and transmitting the confirmed vehicle allocation plan to the specific vehicle. The generating a vehicle allocation plan includes: determining route characteristics with respect to an operation route indicated by the vehicle allocation plan; identifying the vehicle performance of the candidate vehicle based on the vehicle information stored in the vehicle information database; and selecting the candidate vehicle having the vehicle performance matching the determined route characteristics as the specific vehicle.

### Advantageous Effects of Invention

According to the present invention, a vehicle having vehicle performance matching route characteristics is allocated for a vehicle allocation request from a user, and because of this capability, it becomes possible to improve a level of service (LoS).

Other technical features, objects, actions and effects, and advantages of the present invention will become apparent from the following embodiments described with reference to the attached drawings. Advantageous effects described herein are merely illustrative and not restrictive, and may have another advantageous effect.

### BRIEF DESCRIPTION OF DRAWINGS

FIG. 1 is a diagram descriptive of an example of a vehicle allocation management system according to one embodiment of the present invention.

FIG. 2 is a block diagram illustrative of an example of a functional configuration model of a vehicle allocation management device according to the one embodiment of the present invention.

FIG. 3 is a diagram conceptually descriptive of an example of road map information used in the vehicle allocation management system according to the one embodiment of the present invention.

FIG. 4 is a diagram illustrative of a configuration of a vehicle performance requirement table in the vehicle allocation management device according to the one embodiment of the present invention.

FIGS. 5A and 5B are block diagrams illustrative of functional models of control devices installed in vehicles in the vehicle allocation management system according to the one embodiment of the present invention.

FIG. 6 is a sequence chart for a description of an outline of a vehicle allocation service in the vehicle allocation management system according to the one embodiment of the present invention.

FIG. 7 is a flowchart for a description of an example of vehicle allocation management processing by the vehicle allocation management device according to the one embodiment of the present invention.

FIG. 8 is a flowchart for a description of another example of the vehicle allocation management processing by the vehicle allocation management device according to the one embodiment of the present invention.

### DESCRIPTION OF EMBODIMENTS

An embodiment of the present invention will be described below with reference to the drawings. However, the embodiment to be described below is only an example, and there is no intention to exclude various modifications or application of technologies not explicitly described below. The present invention can be subjected to various modifications (such as combining embodiments) without departing from the scope of the present invention. Further, in the following description of the drawings, the same or similar parts are designated by the same or similar reference signs. The drawings are schematic, and dimensions, ratios, or the like do not necessarily coincide with actual dimensions, ratios, or the like. There may also be portions where the dimensional relationship or the ratio differs between the drawings.

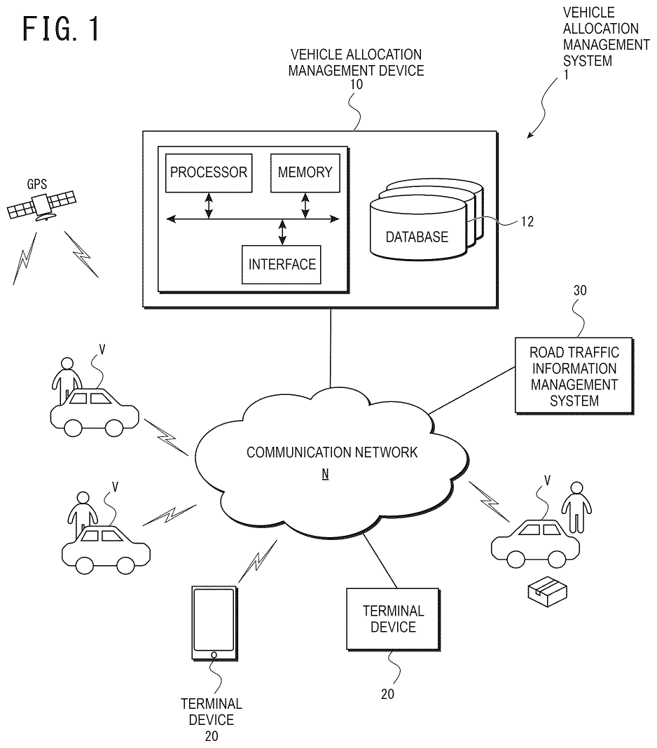

FIG. 1 is a diagram descriptive of an example of a vehicle allocation management system according to one embodiment of the present invention. As illustrated in this figure, a vehicle allocation management system 1 includes a vehicle allocation management device 10, terminal devices 20, and vehicles V, and such constituent elements are communicably connected to one another via a communication network N. Further, the vehicle allocation management system 1 can be connected to a road traffic information management system 30 that provides various traffic information in real time, via the communication network N.

The vehicle allocation management system 1 of the present disclosure provides, for example, a vehicle allocation service based on an on-demand system that targets some area and that uses a plurality of vehicles V. The “vehicle allocation service based on the on-demand system” is a service that immediately responds to a vehicle allocation request from a user and that allocates (dispatches) a predetermined vehicle to the user. In other words, in the vehicle allocation service based on the on-demand system, no vehicle allocation reservation time specified by a user exists. Further, “immediately responding” is a concept that means not only immediately allocating a vehicle in response to a vehicle allocation request from a user but also allocating a vehicle within a period of a certain length generally allowable for the user. Although, in the present disclosure, the vehicle allocation management system 1 assumes such a “vehicle allocation service based on the on-demand system”, the present invention is not limited to such a service and is applicable to, for example, a vehicle allocation service based on a reservation system. Further, the vehicles V include a so-called non-autonomous driving vehicle that a driver drives and a so-called autonomous driving vehicle that is capable of autonomously traveling.

The vehicle allocation management device 10 is a computing device that integrally manages a vehicle allocation service based on a plurality of vehicles V in the target area. The vehicle allocation management device 10 achieves the vehicle allocation service of the present disclosure by, for example, implementing a vehicle allocation management server program and executing the vehicle allocation management server program under the control of a processor.

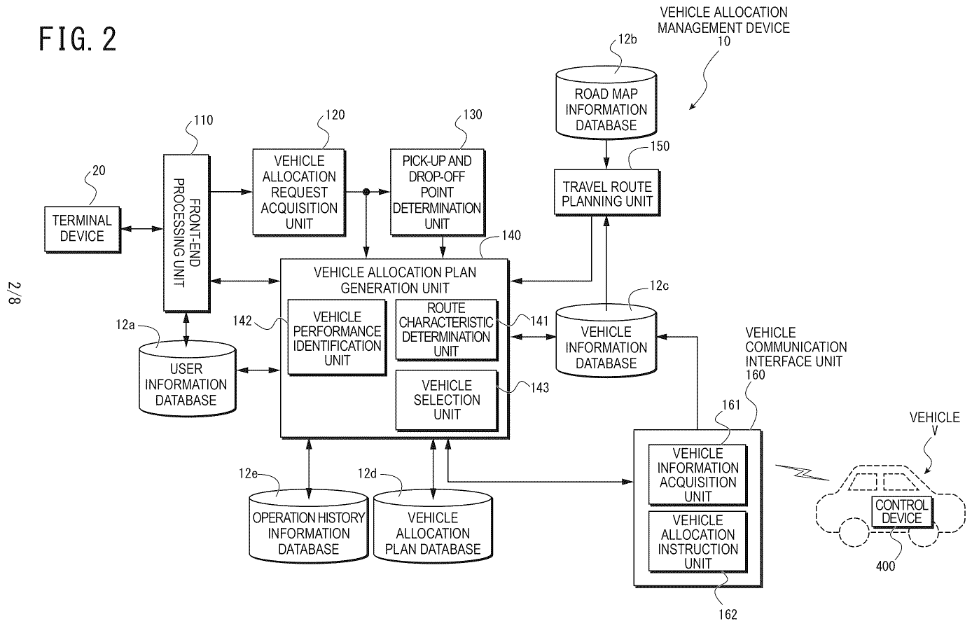

The vehicle allocation management device 10 includes various types of databases 12 that accumulate and manage data required to achieve such a vehicle allocation service. The databases 12 are configured including, for example, a user information database 12a, a road map information database 12b, a vehicle information database 12c, a vehicle allocation plan database 12d, and an operation history information database 12e, as described later (see FIG. 2). Although, in the present example, the databases 12 are formed as a part of the vehicle allocation management device 10, the present invention is not limited to the configuration, and all or some of the databases 12 may be formed as a separate entity.

Schematically, the vehicle allocation management device 10 accepts a vehicle allocation request from a user who desires vehicle allocation for movement using a vehicle V, generates a vehicle allocation plan for each vehicle V serving as a candidate (candidate vehicle v) extracted from a plurality of vehicles V, based on the vehicle allocation request, confirms a vehicle allocation plan corresponding to an optimum vehicle V from the generated vehicle allocation plans, and performs a vehicle allocation instruction in accordance with the confirmed vehicle allocation plan to the vehicle V. The confirmation of a vehicle allocation plan is, for example, performed in response to acceptance of the user.

Although the following description will be made using, as an example, a vehicle allocation request for pick-up from a user who is a passenger, the vehicle allocation request may be a vehicle allocation request for delivery of a package from a user who is a shipper (a package delivery provider or a general person). Therefore, a general user who is not a package delivery provider can also make a vehicle allocation request for package delivery to have a package of the user himself/herself delivered. The vehicle allocation request includes, for example, information about a user name, pick-up and drop-off points (a desired pick-up point and a desired drop-off point), transportation details (the number of passengers and the like), and the like.

The vehicle allocation plan includes an operation route that is a defined route from a place where a vehicle V waits (a waiting place serving as a starting point) to a waiting place serving as an end point (not necessarily the same as the first waiting place) via some intermediate points where a user is picked up or dropped off (pick-up and drop-off points). The vehicle allocation plan can be newly generated based on a new vehicle allocation request in a case where the vehicle V is waiting and can be updated based on a new vehicle allocation request in a case where the vehicle V is in operation. In the present disclosure, the vehicle allocation management device 10 determines, in a vehicle allocation plan that is generated for each candidate vehicle v extracted from a plurality of vehicles V, based on a vehicle allocation request from the user, route characteristics with respect to an operation route of the candidate vehicles v, selects a candidate vehicle v having a vehicle performance matching the route characteristics, and proposes the vehicle allocation plan of the selected candidate vehicle v to the user. The route characteristics are determined based on a risk factor, such as running-out of a person, a crowd of people, a degree of difficulty in driving at an intersection, and a large number of stopping and parking vehicles, in addition to road width, a height restriction, and the like. Since by this configuration, a vehicle V that matches an operation route based on a vehicle allocation request from a user is allocated, it becomes possible to securely operate the vehicles V.

Each vehicle V is a vehicle that is to be provided for use by a user and that is registered in the vehicle information database 12c. A vehicle type (such as a sedan, a mini-van, and an SUV) of the vehicle V does not matter. The vehicle V may be an electric vehicle (EV) that uses an in-vehicle battery as a power source. Further, the vehicle V may be a self-driving vehicle that can perform complete autonomous traveling (an autonomous driving vehicle), and a so-called autonomous driving level does not matter. The vehicle V includes a control device 500 configured to control the vehicle V itself or in-vehicle equipment (e.g., a navigation device) of the vehicle V in accordance with an instruction issued by the vehicle allocation management device 10 (see FIG. 2). The control device 500, for example, acquires geographical position information (hereinafter, referred to as “position information”) of the vehicle V via a GPS system and transmits the position information to the vehicle allocation management device 10, and also accepts a vehicle allocation instruction from the vehicle allocation management device 10 and controls operation of various types of equipment or devices in the vehicle V. The control device 500 includes, for example, a navigation function of presenting an operation route conforming to a vehicle allocation plan to a driver and an autonomous travel control function of, if the vehicle V is an autonomous driving vehicle, determining a detailed actual travel route based on the operation route of the vehicle V and controlling autonomous travel along the actual travel route.

The terminal device 20 is, for example, a computing device for a user who desires to be picked up to make a vehicle allocation request by operating a user interface. The terminal device 20 is, for example, a smartphone, a pad computer, a laptop personal computer, a desktop computer, or the like, but is not limited thereto. The terminal device 20, for example, has a vehicle allocation management client program (a so-called vehicle allocation app) installed therein. The terminal device 20 enables the vehicle allocation service of the vehicle allocation management device 10 to be used by a user by executing the vehicle allocation service app under the control of a processor. For example, the user can make a pick-up reservation for a vehicle V by making a vehicle allocation request from a vehicle allocation request screen (not illustrated) on the user interface of the terminal device 20 and accepting a vehicle allocation plan generated by the vehicle allocation management device 10 in response to the vehicle allocation request.

The road traffic information management system 30 is an information and communication system that provides road traffic information in real time. For example, the road traffic information management system 30 collects road traffic data from vehicle sensors and cameras installed on roads and also collects travel data from the control devices 500 mounted on the vehicles V, and manages road traffic information generated by integrally processing and editing the road traffic data and the travel data. The edited road traffic information may include, for example, information about a road closure and a detour route, required time to travel between points by way of a specific route, or the like. The road traffic information management system 30 provides the vehicle allocation management device 10 and the vehicles V with road traffic information as appropriate.

As described above, since in the vehicle allocation service based on the on-demand system, the vehicle allocation management system 1 of the present disclosure, in response to a vehicle allocation request from a user, generates a vehicle allocation plan for each candidate vehicle v extracted from a plurality of vehicles V, evaluates or determines route characteristics of an operation route in the vehicle allocation plans, and allocates a vehicle V that has vehicle performance matching the route characteristics to the user, it becomes possible to operate the vehicles V safely and securely.

FIG. 2 is a block diagram illustrative of an example of a functional configuration model of the vehicle allocation management device according to the one embodiment of the present invention. As illustrated in this figure, the vehicle allocation management device 10 is configured as a functional configuration model including functional configuration elements, such as a front-end processing unit 110, a vehicle allocation request acquisition unit 120, a pick-up and drop-off point determination unit 130, a vehicle allocation plan generation unit 140, a travel route planning unit 150, and a vehicle communication interface unit 160. Further, the vehicle allocation management device 10 includes various types of databases 12, as described above. Such a functional model is achieved by the vehicle allocation management device 10 executing the vehicle allocation management server program under the control of the processor and thereby collaborating with various types of hardware resources. The functional configuration model described herein is only an example, and all or some functions in a functional configuration element may be achieved by another functional configuration element. It is noted that in the drawing, for the convenience of description, a terminal device 20 of a user and a control device 500 in a vehicle V are also illustrated.

The user information database 12a stores information about a user who uses the vehicle allocation service (hereinafter, referred to as “user information”). The user information includes, for example, information about a user ID, a password, an individual attribute, and a service use status, and the like. The user information is registered in the user information database 12a under the control of the vehicle allocation management device 10 by the user inputting predetermined information at the time of, for example, initial activation of the vehicle allocation app.

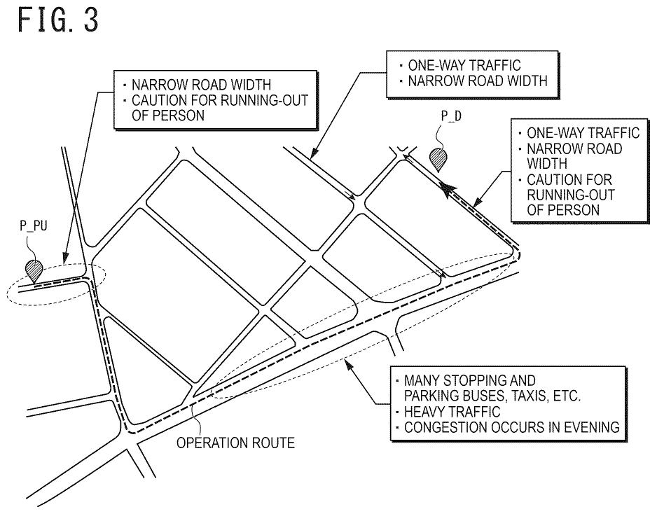

The road map information database 12b stores information about a road map in the target area of the vehicle allocation service (hereinafter, referred to as “road map information”). FIG. 3 is a diagram for a conceptual description of the road map information stored in the road map information database 12b. In the drawing, a reference sign P_PU denotes a desired pick-up point. As illustrated in this figure, the road map information includes map data on, for example, an address, a place-name, a road, and a facility. Further, the road map information may include information required for a route search, such as road information, ground object information, and environment information. The above-described information can include a risk factor in the operation of the vehicles V. The road information includes information about, for example, traffic regulation, such as a speed limit, a one-way road, prohibition of left and right turns, prohibition of parking and stopping, and a road closure, road classification, such as a community road and a main road, and control of a traffic light at an intersection, and the like. The ground object information includes, for example, conditions between a building and a road (e.g., walkway width, existence or nonexistence of a shielding object, such as a guardrail and roadside plants, and a degree of visibility). The environment information includes, for example, a situation of stopping and parking vehicles and pedestrians in each time period at each point, frequency of left and right-turning vehicles at an intersection, frequency of stopping and parking, and frequency of traffic accident occurrence.

Returning to FIG. 2, the vehicle information database 12c stores information about a vehicle V that is provided for use by a user (vehicle information). The vehicle information includes information about, for example, a vehicle ID, a vehicle attribute (a vehicle registration number, a vehicle type, the maximum number of passengers or maximum loading capacity, a non-autonomous driving type or an autonomous driving type, or the like), vehicle performance, other specifications, a current vehicle allocation plan, a current position, and a current state (a service state, a battery remaining capacity (drivable distance), and the number of passengers). The information about vehicle performance (vehicle performance information) includes performance data on, for example, a sensing function, an object identification function, an automatic emergency braking function, an automatic collision avoidance function, and an inter-vehicle distance keeping function, but is not limited thereto. The current position of a vehicle V can be updated as needed based on position information transmitted from the vehicle V.

The vehicle allocation plan database 12d stores a vehicle allocation plan of each vehicle V that is generated by the vehicle allocation plan generation unit 140, based on a vehicle allocation request. The vehicle allocation plan includes an operation route from a waiting place serving as a starting point to a waiting place serving as an end point by way of some pick-up and drop-off points and an expected arrival time at each waypoint.

The operation history information database 12e stores information about, for example, a past operation history of each vehicle V (operation history information). The operation history information includes, for example, various types of specification information, such as operation times (an operation start time and an operation end time), an operation route, and travel distance, of each vehicle V.

It is noted that although not illustrated, the databases 12 can include a driver information database that stores information about a driver who drives a non-autonomous driving vehicle V_NAD (driver information). The driver information includes information about, for example, a driver ID and a password, an individual attribute, a driving career, and a service record.

The front-end processing unit 110 performs various types of processing with a terminal device 20 of a user. As an example, the front-end processing unit 110 performs login authentication processing in accordance with a login request from the vehicle allocation app on the terminal device 20 of the user with reference to the user information database 12a. Further, the front-end processing unit 110 accepts a vehicle allocation request from the vehicle allocation app on the terminal device 20 of the user, passes the vehicle allocation request to the vehicle allocation request acquisition unit 120, and communicates with the terminal device 20 to receive whether the user accepts or refuses a vehicle allocation plan that is generated by the vehicle allocation plan generation unit 140 in response to the vehicle allocation request. That is, the front-end processing unit 110 transmits an acceptance request including the generated vehicle allocation plan to the terminal device 20, causes the terminal device 20 to display the vehicle allocation plan on the user interface of the terminal device 20, and receives a notification of acceptance or refusal transmitted from the terminal device 20 in response to the acceptance request. In this sense, the front-end processing unit 110 also functions as an acceptance processing unit under the control of the vehicle allocation plan generation unit 140.

The vehicle allocation request acquisition unit 120 accepts and acquires a vehicle allocation request from the user via the front-end processing unit 110. A time at which the vehicle allocation request acquisition unit 120 accepts a vehicle allocation request serves as a time counting start time of various types of limit times (such as a pick-up limit time and a drop-off limit time). The vehicle allocation request acquisition unit 120 passes the acquired vehicle allocation request to each of the pick-up and drop-off point determination unit 130 and the vehicle allocation plan generation unit 140.

The pick-up and drop-off point determination unit 130 determines a predetermined pick-up and drop-off points (e.g., a stopping place) that are indicated on a road map and where the user can actually be picked up or dropped off, based on the passed vehicle allocation request with reference to the road map information database 12b. Specifically, the pick-up and drop-off point determination unit 130 determines a pick-up point and a drop-off point that indicate geographical positions where the user can actually be picked up and dropped off in the target area with regard to a desired pick-up point and a desired drop-off point indicated by the vehicle allocation request, with reference to the road map information database 12b. The pick-up and drop-off point determination unit 130 passes the determined pick-up and drop-off points to the vehicle allocation plan generation unit 140.

The vehicle allocation plan generation unit 140, based on a provided vehicle allocation request, extracts vehicles serving as candidates (candidate vehicles v) from the vehicles V in the target area, generates vehicle allocation plans for the candidate vehicles v, selects and confirms a vehicle V having an optimum vehicle allocation plan among the generated vehicle allocation plans, and performs a vehicle allocation instruction conforming to the confirmed vehicle allocation plan to the vehicle V. The vehicle allocation plan generation unit 140 requests the travel route planning unit 150 to derive a route pattern for extraction of candidate vehicles v. The vehicle allocation plan generation unit 140 proposes a generated vehicle allocation plan to the user and confirms the vehicle allocation plan upon receiving acceptance of the vehicle allocation plan from the user. The vehicle allocation plan generation unit 140 may be configured to present a plurality of vehicle allocation plan candidates to the user, cause the user to select a specific vehicle allocation plan from the plurality of vehicle allocation plan candidates, and confirm the selected vehicle allocation plan. The vehicle allocation plan generation unit 140 stores the confirmed vehicle allocation plan in the vehicle allocation plan database 12d and also notifies the vehicle allocation instruction unit 162 to issue a vehicle allocation instruction to a corresponding vehicle V.

In the present disclosure, the vehicle allocation plan generation unit 140 is configured to determine route characteristics of an operation route in a vehicle allocation plan generated based on a vehicle allocation request from a user and select a vehicle V (a specific vehicle V) having a vehicle performance matching the determined route characteristics from the candidate vehicles v. The vehicle allocation plan generation unit 140 is configured including, for example, a route characteristic determination unit 141, a vehicle performance identification unit 142, and a vehicle selection unit 143. Details of the functional configuration elements in the vehicle allocation plan generation unit 140 will be described later.

The travel route planning unit 150 derives a route pattern of each candidate vehicle v under the control of the vehicle allocation plan generation unit 140. The route pattern indicates a route that passes all pick-up and drop-off points in a case where pick-up and drop-off points are added to a route passing determined pick-up and drop-off points (waypoints) due to a new vehicle allocation request. For example, the route pattern can be represented as a lattice structure in which a road is represented by a link and a branch point (intersection) of the road is represented by a node. The travel route planning unit 150 extracts, in response to a route pattern derivation request from the vehicle allocation plan generation unit 140, one or more vehicles V that can match the vehicle allocation request as candidate vehicles v, with reference to the road map information database 12b and the vehicle information database 12c, and derives a route pattern passing through pick-up and drop-off points with respect to each of the extracted candidate vehicles v. Further, the travel route planning unit 150 associates the road map information, including the road information, the ground object information, and the environment information, with the derived route pattern (e.g., links and/or nodes). The travel route planning unit 150 passes the derived route pattern to the vehicle allocation plan generation unit 140.

The vehicle communication interface unit 160 communicates various types of information with the vehicles V via the communication network N. For example, the vehicle communication interface unit 160 includes a vehicle information acquisition unit 161 configured to acquire vehicle information including position information of the vehicles V and the vehicle allocation instruction unit 162 configured to instruct a vehicle V to move in accordance with a vehicle allocation plan.

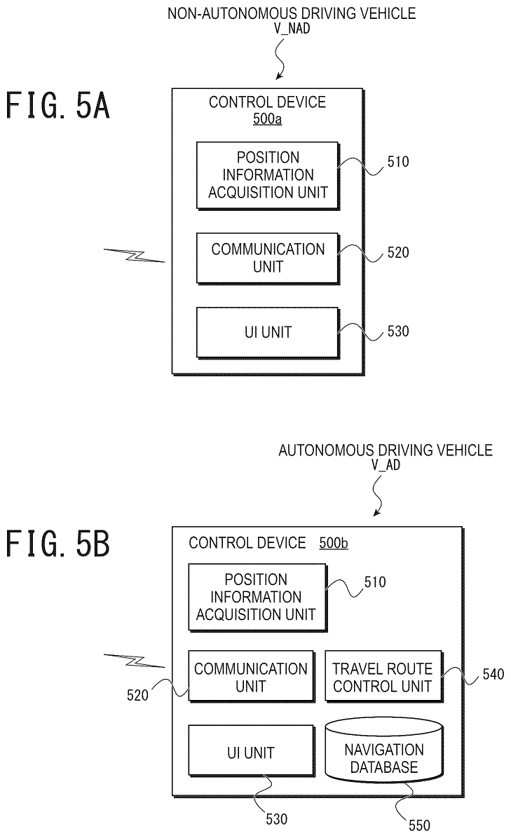

The vehicle information acquisition unit 161 performs communication with a communication unit 520 in the control device 500 and thereby acquires vehicle information including position information acquired by a position information acquisition unit 510 and the like (see FIG. 5). Further, the vehicle allocation instruction unit 162 identifies a corresponding vehicle allocation plan in accordance with an instruction from the vehicle allocation plan generation unit 140 with reference to the vehicle allocation plan database 12d and transmits an operation instruction to a vehicle V in accordance with the identified vehicle allocation plan. The control device 500 of the vehicle V that receives the operation instruction displays a travel route conforming to the vehicle allocation plan on, for example, a user interface (denoted by “UI” in the drawing) 530, using the navigation function. Alternatively, the control device 500 determines a detailed actual travel route in accordance with the operation route in the vehicle allocation plan and performs control in such a way that autonomous travel along the actual travel route is performed.

Next, details of the functional configuration elements in the vehicle allocation plan generation unit 140 will be described.

The route characteristic determination unit 141 determines route characteristics of an operation route in a vehicle allocation plan for a candidate vehicle v. That is, the route characteristic determination unit 141 identifies a risk factor of each of the links/nodes in the operation route and determines route characteristics of the operation route, based on the road map information associated with the links/nodes in the route pattern and the road traffic information acquired from the road traffic information management system 30. By using real-time road traffic information in addition to the road map information, the route characteristic determination unit 141 is capable of determining route characteristics more in accordance with the present situation. The route characteristics can be provided with, for example, a score of 0 to 9 (e.g., the higher the score is, the higher performance a vehicle is required to have). For example, with respect to an operation route including a community road where road width is narrow or an intersection where visibility is poor, a high score is provided to the route characteristics. Further, the score of route characteristics can be calculated according to visibility in each time period (such as evening and night) or the amount of human traffic or vehicle traffic. Further, in a case where a traffic accident occurred at the place in the past, an additional score may be added. The route characteristic determination unit 141 can, for example, calculate a score of a risk factor for each of the links/nodes in the operation route and determine a highest score among the scores of the links/nodes as the score of route characteristics of the operation route. Therefore, it becomes possible to select a candidate vehicle v in accordance with vehicle performance matching route characteristics based on a highest risk factor.

Further, the route characteristic determination unit 141 can determine route characteristics, based on a risk factor of each of the links/nodes indicated by operation history information stored in the operation history information database 12e. For example, if the operation history information includes a sudden braking or an abrupt steering operation in a past travel along the operation route performed by a vehicle V, a high score can be calculated for the route characteristics. By this configuration, a past risk factor obtained from the operation history of a vehicle V can be incorporated into route characteristics.

Further, the route characteristic determination unit 141 can acquire weather information from a weather forecast service site (not illustrated) and use the acquired weather information in calculation of route characteristics of an operation route. For example, since visibility deteriorates if it rains, the score increases.

The vehicle performance identification unit 142 identifies vehicle performance of a candidate vehicle v, based on vehicle information including vehicle performance information of the candidate vehicle v with reference to the vehicle information database 12c. The vehicle performance information includes performance data relating to, for example, a sensing function, an object identification function, an automatic emergency braking function, an automatic collision avoidance function, and an inter-vehicle distance keeping function, but is not limited thereto. The vehicle performance identification unit 142 can calculate a score of vehicle performance according to the vehicle performance information of a vehicle V. For example, the more functions listed above the vehicle V has and/or the higher the performance of the functions is, the higher the score of vehicle performance becomes.

The vehicle selection unit 143 selects, based on the route characteristics determined by the route characteristic determination unit 141 and the vehicle performance identified by the vehicle performance identification unit 142, a vehicle V that has vehicle performance matching the route characteristics from the extracted candidate vehicles v. If a plurality of candidate vehicles v having vehicle performance matching the route characteristics are extracted, the vehicle selection unit 143 selects a candidate vehicle v that has a low score of vehicle performance in a preferential manner. In other words, no problem is posed for the vehicle allocation service as long as the vehicle performance of a vehicle V matches the route characteristics, and by selecting a vehicle V in ascending order of vehicle performance, it becomes possible to keep a vehicle V available for use in a case where a higher vehicle performance is required in the future.

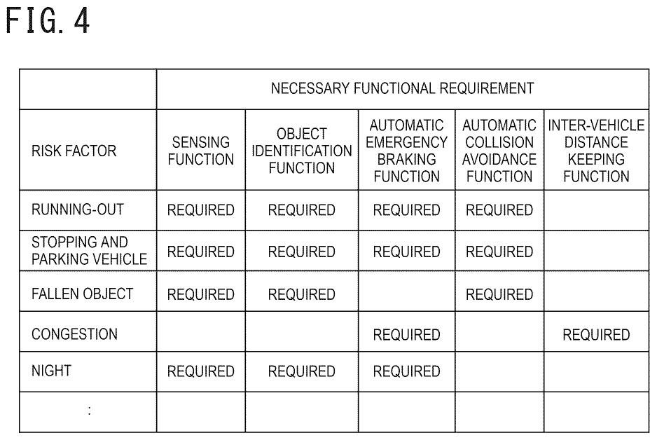

The vehicle selection unit 143 can include, for example, a vehicle performance requirement table that indicates relationships between risk factors and vehicle performance, as illustrated in FIG. 4. The risk factors include categories such as human flow density (a degree of congestion), running-out of a person, a stopping and parking vehicle, a fallen object, congestion, a shielding object, low visibility, a time period, road width, and the number of lanes, but are not limited thereto. Further, necessary functional requirements include, for example, the object identification function, the automatic emergency braking function, the automatic collision avoidance function, and the inter-vehicle distance keeping function, but are not limited thereto. The object identification function is a function of identifying a person or an object (a vehicle, a road, a ground object, or the like), based on an image captured by an optical camera or the like. The automatic emergency braking function is a function of automatically actuating emergency braking at the time of running-out of a person or the like. The automatic collision avoidance function is a function of automatically performing steering operation and changing a course at the time of running-out of a person or the like. The inter-vehicle distance keeping function is a function of keeping constant inter-vehicle distance to a preceding vehicle during traveling. For example, to travel a link/node (road) with which a risk factor representing “running-out” is associated, a vehicle V that is equipped with the sensing function, the object identification function, the automatic emergency braking function, and the automatic collision avoidance function is required. The vehicle selection unit 143 identifies vehicle performance required for the route characteristics of the operation route with reference to the vehicle performance requirement table and selects a vehicle V that has such vehicle performance from the candidate vehicles v.

Further, the vehicle selection unit 143 may select a vehicle V, based on a risk factor of a link/node that has a highest risk factor score among the links/nodes in the operation route. In other words, since route characteristics are determined based on a link/node that has the highest risk factor score by the route characteristic determination unit 141, the vehicle selection unit 143 can select a vehicle V in accordance with the route characteristics. For example, a risk factor score of a link/node where both traffic congestion and human traffic are heavy becomes relatively high. Therefore, the vehicle selection unit 143 can select a vehicle V, based on the highest score of such a risk factor. Since by this configuration, a vehicle V that matches the route characteristics more accurately is selected, operating the vehicle V to a destination safely and appropriately is ensured.

FIG. 5 is block diagrams illustrative of functional models of the control devices installed in vehicles in the vehicle allocation management system according to the one embodiment of the present invention. More specifically, FIG. 5A illustrates a control device 500a installed in a non-autonomous driving vehicle V_NAD, and FIG. 5B illustrates a control device 500b installed in an autonomous driving vehicle V_AD.

As illustrated in FIG. 5A, the control device 500a is configured to include, for example, a position information acquisition unit 510, a communication unit 520, and a user interface unit (denoted by “UI” in the drawing) 530.

The position information acquisition unit 510 acquires position information of the vehicle V from the GPS system. The position information acquisition unit 510 passes the position information acquired from the GPS system to the communication unit 520 to transmit the position information to the vehicle allocation management device 10.

The communication unit 520 is a communication interface for communicating various information with the vehicle communication interface unit 160 of the vehicle allocation management device 10. As an example, the communication unit 520 receives a transmission request of vehicle information transmitted from the vehicle communication interface unit 160 and, in response to the transmission request, transmits vehicle information including position information to the vehicle communication interface unit 160. As another example, the communication unit 520 receives a vehicle allocation instruction transmitted from the vehicle communication interface unit 160 and passes the vehicle allocation instruction to the user interface unit 530.

The user interface unit 530 displays various types of states of the vehicle V to the driver and accepts an input from the driver with respect to the displayed states of the vehicle V. For example, the user interface unit 530 displays a vehicle allocation instruction transmitted from the vehicle allocation management device 10.

On the other hand, the control device 500b illustrated in FIG. 5B differs from the control device 500a in that the control device 500b further includes, for example, a travel route control unit 540 and a navigation database 550 in addition to the configuration of the control device 500a. It is noted that the user interface unit 530 of the autonomous driving vehicle V_AD can be used to provide a user on board the autonomous driving vehicle V_AD with various information.

The travel route control unit 540 determines an actual travel route, based on various road map information stored in the navigation database 550 in accordance with a vehicle allocation plan provided from the vehicle allocation management device 10. Further, the travel route control unit 540 can determine a travel route, based on road traffic information acquired from the road traffic information management system 30. In other words, although in the present disclosure, a vehicle allocation plan generated by the vehicle allocation management device 10 based on a vehicle allocation request includes an operation route that links waypoints (a pick-up point and a drop-off point) and that serves as a reference, a required time, and the like, determination of a travel route matching actual road traffic conditions is entrusted to the autonomous driving vehicle V_AD. Therefore, the travel route control unit 540 of the autonomous driving vehicle V_AD determines an actual travel route, based on the vehicle allocation plan with reference to the navigation database 550 of the autonomous driving vehicle V_AD itself. The control device 500b controls autonomous travel of the autonomous driving vehicle V_AD in accordance with the travel route determined by the travel route control unit 540. The travel route control unit 540 can transmit travel data of the autonomous driving vehicle V_AD to the vehicle allocation management device 10 via the communication unit 520.

The navigation database 550 stores navigation information for autonomous travel of the vehicle V in the target area of the vehicle allocation service. The navigation information typically includes road traffic information, travel history information, and the like. Although the navigation database 550 of the autonomous driving vehicle V_AD is schematically the same as the above-described road map information database 12b in including the road map information, the navigation database 550 differs from the road map information database 12b in that the stored road map information and travel history information are updated, based on an actual autonomous travel of the autonomous driving vehicle V_AD. The travel route control unit 540, for example, updates the road map information and the travel history information in the navigation database 550 in association with autonomous travel along the determined travel route. For example, the road map information can be refined by the update. The navigation database 550 may include, for example, a street view of the travel route that the autonomous driving vehicle V_AD autonomously traveling captured.

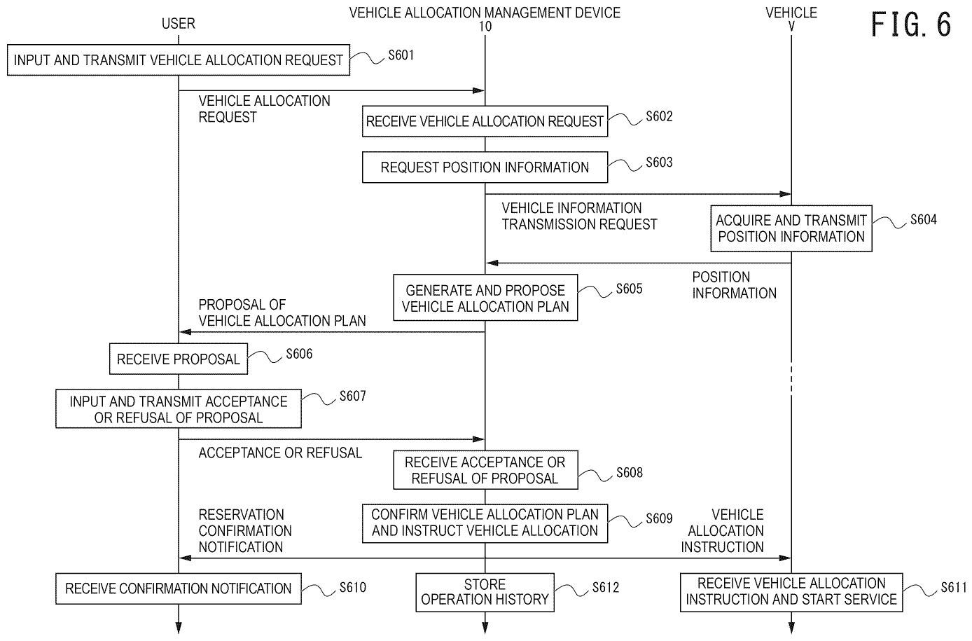

FIG. 6 is a sequence chart for a description of an outline of the vehicle allocation service in the vehicle allocation management system according to the one embodiment of the present invention.

As illustrated in this figure, a user who is to use the vehicle allocation service executes the vehicle allocation app installed in the terminal device 20 and inputs information required for a vehicle allocation request on the vehicle allocation request screen displayed on the user interface, and the terminal device 20 thereby transmits the vehicle allocation request to the vehicle allocation management device 10 (S601). For example, a user who desires to be picked up (desires to make a vehicle allocation reservation) inputs a pick-up point, a drop-off point, the number of passengers, and the like by operating the vehicle allocation app. The pick-up point and the drop-off point can, for example, be selected from a geographical map displayed by the vehicle allocation app. Further, the pick-up point may be a current position that is acquired by a GPS function installed in a smartphone of the user.

If the vehicle allocation management device 10 receives the vehicle allocation request from the terminal device 20 (S602), the vehicle allocation management device 10 requests acquisition of vehicle information including position information to vehicles V in the target area (S603). In response to the request, each vehicle V transmits vehicle information including position information of the vehicle V itself, which is acquired from the GPS system, to the vehicle allocation management device 10 (S604). It is noted that the acquisition and transmission of the position information by the vehicle V may be performed on a periodic basis or in response to a transmission request from the vehicle allocation management device 10. The vehicle allocation management device 10 acquires the vehicle information including the position information transmitted from the vehicle V.

Next, the vehicle allocation management device 10 generates a vehicle allocation plan of a candidate vehicle v extracted based on the vehicle allocation request of the user and proposes the generated vehicle allocation plan to the user (S605). That is, the vehicle allocation management device 10 derives a route pattern based on the vehicle allocation request and generates a vehicle allocation plan of the extracted candidate vehicle v, based on the derived route pattern. On this occasion, the vehicle allocation management device 10 determines route characteristics of an operation route based on the vehicle allocation request and also identifies vehicle performance of each candidate vehicle v, selects a candidate vehicle v that has vehicle performance matching the route characteristics in accordance with the vehicle performance requirement table, and extracts a vehicle allocation plan of the candidate vehicle v. The vehicle allocation management device 10 transmits an acceptance request including a content of the vehicle allocation plan to the terminal device 20 to propose the selected vehicle allocation plan to the user.

If the terminal device 20 receives the acceptance request of the vehicle allocation plan, the terminal device 20 displays the acceptance request on the user interface as a vehicle allocation plan proposal screen and prompts the user to accept or refuse (acceptance or refusal) the proposed vehicle allocation plan (S606). The vehicle allocation plan proposal screen can include, for example, specific locations of the pick-up and drop-off points at which the vehicle V arrives, expected arrival times, and the like. The user can input acceptance or refusal of the proposed vehicle allocation plan on the vehicle allocation plan proposal screen. If the user inputs acceptance or refusal on the vehicle allocation plan proposal screen, the terminal device 20, upon receiving the input, transmits an acceptance or refusal notification to the vehicle allocation management device 10 (S607), and the vehicle allocation management device 10 receives the acceptance or refusal notification transmitted from the terminal device 20 (S608). For example, if the acceptance or refusal notification is a notification indicating acceptance of the vehicle allocation plan, the vehicle allocation management device 10 confirms the vehicle allocation plan of the vehicle V conforming to the vehicle allocation plan, transmits a confirmation notification of a vehicle allocation reservation to the terminal device 20, and also transmits a vehicle allocation instruction conforming to the vehicle allocation plan to the vehicle V (S609).

If the terminal device 20 receives the confirmation notification of the vehicle allocation reservation, the terminal device 20 displays the confirmation notification on the user interface and notifies the user of confirmation of the vehicle allocation reservation (S610). On the other hand, if the vehicle V receives the vehicle allocation instruction, the vehicle V executes vehicle allocation service in accordance with the vehicle allocation plan (S611). That is, In a case where the vehicle V instructed to be allocated is an autonomous driving vehicle V_AD, the autonomous driving vehicle V_AD plans a specific travel route in accordance with the vehicle allocation plan and starts autonomous travel to travel to the pick-up and drop-off points to pick up the user who made the vehicle allocation request. Alternatively, in a case where the vehicle V instructed to be allocated is a non-autonomous driving vehicle V_NAD, the non-autonomous driving vehicle V_NAD displays an operation route conforming to the vehicle allocation plan indicated by the vehicle allocation instruction on, for example, a navigation screen to navigate the driver. By this configuration, the vehicle allocation service of a vehicle V based on the on-demand system in response to a vehicle allocation request from a user is achieved.

When operation of the vehicle V conforming to the vehicle allocation plan based on the vehicle allocation request is completed, the vehicle allocation management device 10 stores operation history information of the vehicle V in the operation history information database 12e (S612). The operation history information stored in the operation history information database 12e is used for the next determination of route characteristics for the vehicle V.

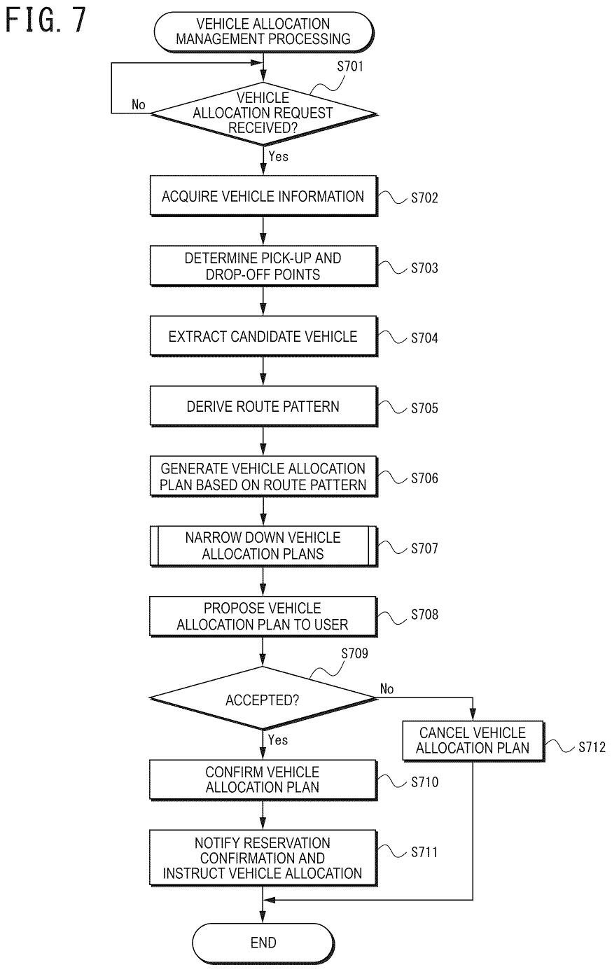

FIG. 7 is a flowchart for a description of an example of the vehicle allocation management processing by the vehicle allocation management device according to the one embodiment of the present invention. Such processing is achieved by the vehicle allocation management device 10 executing the vehicle allocation management server program under the control of the processor and collaboration with various types of hardware resources thereby being performed.

As illustrated in this figure, the vehicle allocation management device 10 waits until receiving a new vehicle allocation request from a user (S701). In the meantime, for example, a user who desires to be picked up inputs a vehicle allocation request by operating the vehicle allocation app on the user interface of a terminal device 20. If the vehicle allocation management device 10 receives the vehicle allocation request from the user (Yes in S701), the vehicle allocation management device 10 requests each vehicle V to transmit vehicle information and acquires vehicle information including position information transmitted from each vehicle V (S702).

Subsequently, the vehicle allocation management device 10 determines a pick-up point and a drop-off point (pick-up and drop-off points) for the user to be actually picked up and dropped off, based on a desired pick-up point and a desired drop-off point indicated by the vehicle allocation request with reference to the road map information database 12b (S703).

Next, the vehicle allocation management device 10 extracts one or more candidate vehicles v in accordance with the determined pick-up point and drop-off point (S704). For example, the vehicle allocation management device 10 extracts a vehicle V in operation in a vicinity of the pick-up point as a candidate vehicle v. The vehicle V in operation is a vehicle that waits at a waiting place while being ready to provide a service or that is actually transporting a passenger. By this configuration, for example, a vehicle V that is located far away from the pick-up point or the drop-off point can be excluded from candidate vehicles v and the number of route patterns to be derived can be reduced.

Next, the vehicle allocation management device 10 derives a route pattern with respect to each of the extracted candidate vehicles v with reference to the road map information database 12b (S705). As described above, the route pattern indicates a route that, if new pick-up and drop-off points are added to a route passing through determined pick-up and drop-off points (waypoints), passes through all the pick-up and drop-off points. Subsequently, the vehicle allocation management device 10 generates a vehicle allocation plan, based on the derived route pattern (S706). The route pattern can be represented by a lattice structure consisting of links (roads) and nodes (intersections), as described above. The vehicle allocation plan includes a waiting place serving as a starting point of the route pattern, a waiting place serving as an end point of the route pattern, and an operation route. A vehicle allocation plan of a vehicle V waiting at a waiting place is newly generated. Further, the vehicle allocation plan of a vehicle V that is in operation in accordance with an existing vehicle allocation plan is updated based on the derived route pattern.

Then, the vehicle allocation management device 10 narrows down vehicle allocation plans (candidate vehicles v) by excluding a vehicle allocation plan satisfying a predetermined exclusion condition among generated vehicle allocation plans of the candidate vehicles v (S707). For example, the vehicle allocation management device 10 excludes a vehicle allocation plan of a candidate vehicle v the drivable distance of which is less than a predetermined threshold value. By this configuration, a candidate vehicle v that does not satisfy the vehicle allocation request from the user is excluded. Further, in the present disclosure, the vehicle allocation management device 10 narrows down the vehicle allocation plans of the candidate vehicles v by selecting a candidate vehicle v that has vehicle performance matching route characteristics of the operation route based on the vehicle allocation request. If a plurality of candidate vehicles v having vehicle performance matching the route characteristics are extracted, the vehicle allocation management device 10 can select a candidate vehicle v that has a low or lowest score of vehicle performance.

Subsequently, the vehicle allocation management device 10 proposes a content of the selected vehicle allocation plan to the user (S708). That is, the vehicle allocation management device 10 transmits a content of the generated current vehicle allocation plan to the terminal device 20, and the terminal device 20 displays, in response to the transmission, the content of the current vehicle allocation plan on the user interface and prompts the user to accept or refuse the vehicle allocation plan.

The vehicle allocation management device 10 determines whether or not the vehicle allocation management device 10 has accepted an acceptance of the proposal of the vehicle allocation plan from the user (S709). If the vehicle allocation management device 10 has accepted an acceptance of the proposal of the vehicle allocation plan from the user (Yes in S709), the vehicle allocation management device 10 confirms the current vehicle allocation plan (S710). The vehicle allocation management device 10 stores the confirmed vehicle allocation plan in the vehicle allocation plan database 12d. Subsequently, the vehicle allocation management device 10 transmits a confirmation notification of the vehicle allocation reservation to the terminal device 20 and also transmits a vehicle allocation instruction based on the vehicle allocation plan to the vehicle V (S711).

In contrast, if the vehicle allocation management device 10 has accepted a non-acceptance (refusal) of the proposal of the vehicle allocation plan from the user (No in S709), the vehicle allocation management device 10 cancels the current vehicle allocation plan based on the vehicle allocation request of the user (S710). In this case, the vehicle allocation management device 10 returns the vehicle allocation plan that was used for regeneration of a vehicle allocation plan and that has been temporarily reserved to the original pending vehicle allocation plan. If the user requests another vehicle allocation service, the user is to make a new vehicle allocation request.

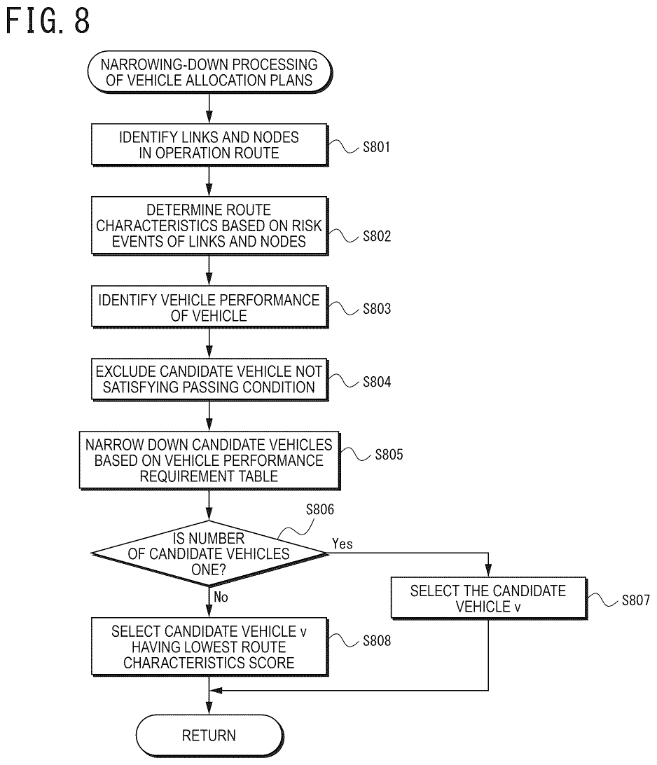

FIG. 8 is a flowchart for a description of another example of the vehicle allocation management processing by the vehicle allocation management device according to the one embodiment of the present invention. More specifically, the drawing is a flowchart illustrative of details of the narrowing-down processing of vehicle allocation plans (S707) illustrated in FIG. 7.

As illustrated in this figure, the vehicle allocation management device 10 identifies links/nodes constituting an operation route in the generated vehicle allocation plan, based on the road map information associated with a route pattern derived by the travel route planning unit 150 (S801). Then, the vehicle allocation management device 10 calculates a score, based on a risk factor of each of the identified links/nodes and determines route characteristics of the operation route, based on the calculated scores (S802). The risk factor of each of the links/nodes is acquired based on the road map information associated with the route pattern derived by the travel route planning unit 150 and road traffic information acquired from the road traffic information management system 30. Further, the vehicle allocation management device 10 can calculate a score, based on weather information in the area.

Next, the vehicle allocation management device 10 acquires vehicle information of each candidate vehicle v with reference to the vehicle information database 12c and identifies vehicle performance, based on attribute information, vehicle performance information, and the like included in the vehicle information (S803). For example, the vehicle performance of a vehicle V that is equipped with a sensing function, such as a high-resolution image sensor, and an advanced object identification function has a higher score of vehicle performance than a vehicle V that is not equipped with such functions.

Next, the vehicle allocation management device 10 narrows down candidate vehicles v that have vehicle performance matching the determined route characteristics and selects a candidate vehicle v. Specifically, the vehicle allocation management device 10 first excludes a candidate vehicle v that does not satisfy a passing condition of the links/nodes in the operation route (S804). In other words, since a vehicle V cannot operate to the destination to begin with unless being able to pass a road with a vehicle width restriction or a height restriction in the operation route, the vehicle allocation management device 10 excludes such a vehicle V from the candidate vehicles v. Examples of the passing condition include a weight restriction and a restriction on turning radius in an intersection in addition to a road width restriction and a height restriction, but are not limited thereto. By this configuration, it is possible to prevent a vehicle V the vehicle attribute of which does not fit the operation route from being allocated.

Next, the vehicle allocation management device 10 extracts a candidate vehicle v that matches the risk factors of the links/nodes in the operation route with reference to the vehicle performance requirement table (S805). For example, if in the vehicle performance requirement table illustrated in FIG. 4, a risk factor at a link/node is running-out of a person, a candidate vehicle v is required to have the sensing function, the object identification function, the automatic emergency braking function, and the automatic collision avoidance function. Therefore, the vehicle allocation management device 10 narrows down candidate vehicles v to a candidate vehicle v that has the above-described functions.

Next, the vehicle allocation management device 10 determines whether or not the number of narrowed-down candidate vehicles v is one (S806). If the vehicle allocation management device 10 determines that the number of narrowed-down candidate vehicles v is one (Yes in S806), the vehicle allocation management device 10 selects the candidate vehicle v as a vehicle V to be proposed to the user (S807).

In contrast, if the vehicle allocation management device 10 determines that the number of narrowed-down candidate vehicles v is not one (No in S806), the vehicle allocation management device 10 selects a candidate vehicle v that has the lowest score of vehicle performance (S808).

In a manner as described above, if the vehicle allocation management device 10 accepts a vehicle allocation request from a user, the vehicle allocation management device 10 generates a vehicle allocation plan for a candidate vehicle v extracted in accordance with the vehicle allocation request, and further determines route characteristics of an operation route in the vehicle allocation plan and also acquires vehicle performance of candidate vehicles v, selects a candidate vehicle v as a specific vehicle V that has vehicle performance matching the determined route characteristics, and proposes the vehicle allocation plan to the user. Since by this configuration, a vehicle V that has vehicle performance matching the route characteristics is allocated to the user, it becomes possible to operate the vehicle V safely and securely and improve a level of service (LoS).

The above-described embodiments are examples for describing the present invention and are not intended to limit the present invention only to the embodiments. The present invention can be implemented in a variety of modes without departing from the scope and spirit of the present invention

For example, in the method disclosed herein, the steps, operations, or functions may be implemented concurrently or in different orders, as long as there is no inconsistency in the result. The described steps, operations, and functions have been provided as just examples, and in the scope without departing from the spirit of the present invention, some of the steps, operations, and functions can be omitted or can be combined with each other into one, and other steps, operations, or functions may be added.

Further, although a variety of embodiments are disclosed herein, a particular feature (technical matter) in an embodiment can be appropriately improved, and therewith, can be added to an alternative embodiment or can be replaced by the particular feature in the alternative embodiment, and such modes also fall within the spirit of the present invention.

### REFERENCE SIGNS LIST

1 Vehicle allocation management system
10 Vehicle allocation management device
110 Front-end processing unit
120 Vehicle allocation request acquisition unit
130 Pick-up and drop-off point determination unit
140 Vehicle allocation plan generation unit
141 Route characteristic determination unit
142 Vehicle performance identification unit
143 Vehicle selection unit
150 Travel route planning unit
160 Vehicle communication interface unit
161 Vehicle information acquisition unit
162 Vehicle allocation instruction unit
12 Database
12a User information database
12b Road map information database
12c Vehicle information database
12d Vehicle allocation plan database
12e Operation history information database
20 Terminal device
N Communication network
V Vehicle
500, 500a, 500b Control device
510 Position information acquisition unit
520 Communication unit
530 User interface unit
540 Travel route control unit
550 Navigation database

1. A vehicle allocation management device for managing allocation of a vehicle in response to a vehicle allocation request, comprising:
a vehicle allocation request acquisition unit configured to acquire a vehicle allocation request in which at least a desired pick-up point is indicated;
a vehicle information database configured to store vehicle information including information about vehicle performance and associated with each of a plurality of vehicles;
an operation history information database configured to store operation history information of each of the vehicles operated in accordance with the vehicle allocation instruction;
a vehicle allocation plan generation unit configured to generate a vehicle allocation plan including at least an operation route with respect to each of two or more candidate vehicles being extracted from the plurality of vehicles based on the acquired vehicle allocation request, and to confirm the vehicle allocation plan of a specific vehicle selected from the generated vehicle allocation plans; and
a vehicle allocation instruction unit configured to transmit the confirmed vehicle allocation plan to the specific vehicle,
wherein the vehicle allocation plan generation unit includes:
a route characteristic determination unit configured to determine route characteristics with respect to the operation route;
a vehicle performance identification unit configured to identify vehicle performance of the candidate vehicle, based on the vehicle information stored in the vehicle information database; and
a vehicle selection unit configured to select the specific vehicle having the vehicle performance matching the determined route characteristics,
wherein the route characteristic determination unit determines the route characteristics based on risk factors of links/nodes in the operation route indicated by the operation history information stored in the operation history information database.

2. The vehicle allocation management device according to claim 1, wherein if a plurality of the candidate vehicles having the vehicle performance matching the route characteristics exist, the vehicle selection unit selects the candidate vehicle having a low score of the calculated vehicle performance as the specific vehicle.

3. The vehicle allocation management device according to claim 1, wherein the route characteristic determination unit determines a score of the route characteristics based on a risk factor relating to sudden braking and/or emergency braking of each of links/nodes in the operation route indicated by the operation history information stored in the operation history information database.

4. The vehicle allocation management device according to claim 1, wherein the route characteristic determination unit calculates a score of the risk factor for each of the links/nodes and determines a higher score among the scores of the links/nodes as a score of the route characteristics.

5. (canceled)

6. The vehicle allocation management device according to claim 1, wherein the route characteristic determination unit determines the route characteristics of the operation route, based on the risk factors of the links/nodes indicated by road map information.

7. The vehicle allocation management device according to claim 1, wherein the vehicle selection unit includes a vehicle performance requirement table indicating a relationship between the risk factor and the vehicle performance.

8. The vehicle allocation management device according to claim 7, wherein in the vehicle performance requirement table, the vehicle performance is defined for each category of the risk factor.

9. The vehicle allocation management device according to claim 8, wherein the category of the risk factor includes at least one of human flow density, running-out of a person, a stopping and parking vehicle, a fallen object, congestion, a shielding object, low visibility, a time period, road width, and a number of lanes.

10. The vehicle allocation management device according to claim 8, wherein the vehicle performance includes at least one of a target object detection function, a target object recognition function, an automatic emergency braking function, an automatic collision avoidance function, and an inter-vehicle distance keeping function.

11. The vehicle allocation management device according to claim 7, wherein the vehicle selection unit selects the specific vehicle having the vehicle performance matching the route characteristics in accordance with the vehicle performance requirement table.

12. The vehicle allocation management device according to claim 2, wherein the vehicle selection unit selects the specific vehicle, based on the risk factor of the link/node having a highest score of the risk factor among the links/nodes in the operation route.

13. The vehicle allocation management device according to claim 1, wherein the route characteristic determination unit determines the route characteristics, based on road traffic information acquired from an external road traffic information management system.

14. A vehicle allocation management method performed by a vehicle allocation management device configured to manage allocation of a vehicle in response to a vehicle allocation request, the vehicle allocation management method comprising:
storing vehicle information including information about vehicle performance and associated with each of a plurality of vehicles, in a vehicle information database;
storing operation history information of each of the vehicles operated in accordance with the vehicle allocation instruction in an operation history information database;
acquiring a vehicle allocation request in which at least a desired pick-up point is indicated from a terminal device of a user;
generating a vehicle allocation plan including at least an operation route with respect to each of two or more candidate vehicles extracted from the plurality of vehicles based on the acquired vehicle allocation request;
confirming the vehicle allocation plan of a specific vehicle selected from the generated vehicle allocation plans; and
transmitting the confirmed vehicle allocation plan to the specific vehicle,
wherein the generating a vehicle allocation plan includes:
determining route characteristics with respect to an operation route indicated by the vehicle allocation plan;
identifying the vehicle performance of the candidate vehicle, based on the vehicle information stored in the vehicle information database; and
selecting the candidate vehicle having the vehicle performance matching the determined route characteristics as the specific vehicle, and
wherein the determining the route characteristic includes determining the route characteristics based on risk factors of links/nodes in the operation route indicated by the operation history information stored in the operation history information database.

15. A vehicle allocation management device for managing allocation of a vehicle in response to a vehicle allocation request, comprising:
a vehicle allocation request acquisition unit configured to acquire a vehicle allocation request in which at least a desired pick-up point is indicated;
a vehicle information database configured to store vehicle information including information about vehicle performance and associated with each of a plurality of vehicles;
a vehicle allocation plan generation unit configured to generate a vehicle allocation plan including at least an operation route with respect to each of two or more candidate vehicles extracted from the plurality of vehicles based on the acquired vehicle allocation request, and to confirm the vehicle allocation plan of the specific vehicle, the vehicle allocation plan being selected from the generated vehicle allocation plans; and
a vehicle allocation instruction unit configured to transmit the confirmed vehicle allocation plan to the specific vehicle,
wherein the vehicle allocation plan generation unit includes:
a route characteristic determination unit configured to determine route characteristics with respect to the operation route;
a vehicle performance identification unit configured to identify vehicle performance of the candidate vehicle based on the vehicle information stored in the vehicle information database; and
a vehicle selection unit configured to select the specific vehicle having the vehicle performance matching the determined route characteristics, and
wherein the vehicle selection unit selects, if a plurality of the candidate vehicles having the vehicle performance matching the route characteristics exist, the candidate vehicle having a lowest score of the calculated vehicle performance as the specific vehicle.
